(19) United States
(12) Patent Application Publication
(10) Pub. No.: US 2015/0007156 A1
(43) Pub. Date: Jan. 1, 2015

(54) INJECTING PATCH CODE AT RUNTIME

(71) Applicants: Vladimir Tkach, Kfar Yona (IL); Nati Ari, Zoran (IL)

(72) Inventors: Vladimir Tkach, Kfar Yona (IL); Nati Ari, Zoran (IL)

(73) Assignee: SAP AG, Walldorf (DE)

(21) Appl. No.: 13/927,721

(22) Filed: Jun. 26, 2013

(51) Int. Cl. G06F 9/445

(52) U.S. Cl. CPC G06F 8/67
USPC 717/170

(57) ABSTRACT

The disclosure generally describes computer-implemented methods, software, and systems for using productive code. A copy of productive code is accessed. The copy of productive code is presented in an editor for generating injectable code, the injectable code including a patched version of the productive code including patch-specific language keywords. User inputs are received for modifying the patched version. The patched version is stored at a server for subsequent use by at least one client for injecting the injectable code into the productive source code at runtime without modifying the productive code.

### TECHNICAL FIELD

The present disclosure relates to computer-implemented methods, software, and systems for executing code.

### BACKGROUND

Software development processes can include many stages relative to application code, including design, development, testing, installation and maintenance. Ideally, productive code, once it is developed and installed, should not be changed, except to correct known deficiencies and/or to add features. Various techniques can be used to test code before it is made productive. For example, debuggers can be used to trace the execution of code and determine errors. Stub programs can be used, for example, to simulate the functionality of called methods, procedures and other subordinate or parallel software components. Drivers, for example, can be used to drive the execution of lower-level software components. Diagnostic lines of code can be added to application code, and then later removed when testing is complete.

### SUMMARY

The disclosure generally describes computer-implemented methods, software, and systems for providing instructions for generating injectable code and injecting the code at runtime. As an example, a copy of productive code is accessed, e.g., at a server, and presented in an editor for generating injectable code. The injectable code includes a patched version of the productive code, including patch-specific language keywords. User inputs for modifying the patched version are received. The patched version is stored at a server for subsequent use by at least one client for injecting the injectable code into the productive source code at runtime without modifying the productive code. In another example, e.g., at a client, a copy of productive code is received from a server. Injectable code is received from the server. The injectable code includes a patched version of the productive code including patch-specific language keywords. A command is received to execute the injectable code. The injectable code is injected into the source code for execution at runtime without modifying the productive code. Results of the execution are reported to the server.

The present disclosure relates to computer-implemented methods, software, and systems for providing and executing diagnostic code. One computer-implemented method includes: accessing a copy of productive code; presenting the copy of productive code in an editor for generating injectable code, the injectable code including a patched version of the productive code including patch-specific language keywords; receiving user inputs for modifying the patched version; and storing the patched version at a server for subsequent use by at least one client for injecting the injectable code into the productive source code at runtime without modifying the productive code. Another computer-implemented method includes: receiving a copy of productive code from a server; receiving injectable code from the server, the injectable code including a patched version of the productive code including patch-specific language keywords; receiving a command to execute the injectable code; injecting the injectable code into the source code for execution at runtime without modifying the productive code; and reporting results of the execution to the server.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation can include all the following features:

In a first aspect combinable with any of the previous aspects, the method further includes: providing, to the at least one client, a command to use the injectable code for an execution of the productive code; receiving, after subsequent execution of the injectable code, information reporting results of the execution; and storing the information for subsequent analysis.

In a second aspect combinable with any of the previous aspects, the method further includes receiving a designation of a group identifier for grouping one or more productive code elements into a group, wherein the command includes the group identifier identifying the one or more productive code elements of the injectable code to be injected for the execution.

In a third aspect combinable with any of the previous aspects, productive code includes productive code elements selected from the group comprising source code, business objects, data bases, data tables, flat files, or programmable read-only memory.

In a fourth aspect combinable with any of the previous aspects, the patched version invokes the productive code.

In a fifth aspect combinable with any of the previous aspects, the patch-specific language keywords include: a before keyword for identifying code to run before executing the productive code; an after keyword for identifying code to run after executing the productive code; a within keyword for triggering an execution of the productive code; an around keyword for executing specified code before and after executing the productive code; a fnArgs keyword for defining new arguments for the function; and a super flag for specifying whether or not to run the original functionality.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example environment for providing and executing diagnostic code.

FIGS. 2-3 are block diagrams of examples of runtime substitution of injectable code.

FIG. 4A is a flowchart of an example method for producing injectable code and storing the injectable code at a server for subsequent use.

FIG. 4B is a flowchart of an example method for using injectable code at a client, including injecting the injectable code at runtime.

Like reference numbers and designations in the various drawings indicate like elements.

### DETAILED DESCRIPTION

This disclosure generally describes computer-implemented methods, software, and systems for executing code. For example, one method can include accessing a copy of productive code; presenting the copy of productive code in an editor for generating injectable code, the injectable code including a patched version of the productive code including patch-specific language keywords; receiving user inputs for modifying the patched version; and storing the patched version at a server for subsequent use by at least one client for injecting the injectable code into the productive source code at runtime without modifying the productive code. Another computer-implemented method includes: receiving a copy of productive code from a server; receiving injectable code from the server, the injectable code including a patched version of the productive code including patch-specific language keywords; receiving a command to execute the injectable code; injecting the injectable code into the source code for execution at runtime without modifying the productive code; and reporting results of the execution to the server.

The subject matter described in this specification can be implemented in particular implementations so as to realize one or more of the following advantages. Without changing productive code, problems can be solved at a customer site, including trouble-shooting and fixing functions, adding logs and traces to functions, simulating server responses, and adding function parameter validation. Injectable code can be used, for example, to replace or change the body of a function, change or add function arguments, validate function arguments types, run productive functionality before and/or after injected code, and replace a function to run the original function.

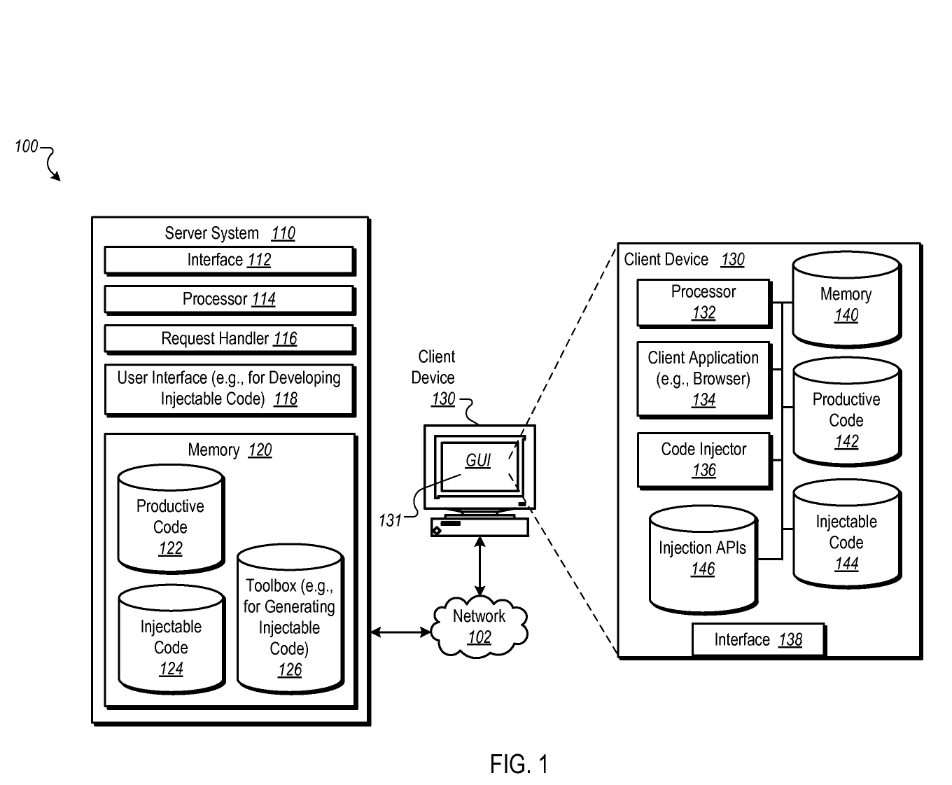

FIG. 1 illustrates an example environment 100 for providing and executing diagnostic code. Specifically, the illustrated environment 100 includes at least one server system 110, and at least one client device 130, all of which are communicably coupled using a network 102. For example, a user interacting with a user interface presented on the client device 130 may interact with productive code provided by the server system 110. At certain times, when the productive code executes at the client device 130, injectable code can also execute, e.g., replacing or modifying one or more components of productive code so as to achieve a different result, obtain diagnostics, provide other information regarding the execution of code, or for other reasons. In some implementations, user interaction may not be part of interactions with the client device 130. For example, the client device 130 can be an embedded computer device, such as an implantable medical device, an airline/defense control system, or other application that can run in real-time without interactive user input.

The server system 110 comprises an electronic computing device operable to provide productive code 122 and injectable code 124. The productive code 122 may be provided to one or more client devices 130, e.g., for running applications, presenting browsers on web pages, or for other purposes. Productive code 122 can include, for example, data used by the productive code, including source code, business objects, data bases, data tables, flat files, programmable read-only memory, and/or other types or formats of data in other structures or provided in other ways.

The injectable code 124 can include, for example, patched (e.g., modified) versions of the productive code 122. The patched versions can include patched versions of software programs, method, subroutines and/or any other components that are executed or used at runtime. Patched versions can have associated names so that, for example, the patched versions can be substituted for the productive versions at runtime.

In some implementations, the injectable code 124 can be developed at the server system by software engineers, programmers or obtained from other sources and stored at the server system 110. There can be multiple server systems 110, each having productive code 122 and injectable code 124 that can be used by multiple client devices 130. Also, productive code 122 can be used at the server system 110 and other systems for use in generating and/or testing injectable code 124.

As used in the present disclosure, the term “computer” is intended to encompass any suitable processing device. For example, although FIG. 1 illustrates a single server system 110, the environment 100 can be implemented using two or more server systems 110. The environment 100 can also be implemented using computers other than servers, including a server pool. Indeed, components of the environment 100 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated components of the environment 100 may be adapted to execute any operating system, including Linux, UNIX, Windows, Mac OS®, Java™, Android™, iOS or any other suitable operating system. According to some implementations, components of the environment 100 may also include, or be communicably coupled with, an e-mail server, a Web server, a caching server, a streaming data server, and/or other suitable server(s). In some implementations, components of the environment 100 may be distributed in different locations and coupled using the network 102.

The server system 110 includes an interface 112, a processor 114, a request handler 116, a user interface 118, and a memory 120. The interface 112 is used by the server system 110 for communicating with other systems in a distributed environment, connected to the network 102 (e.g., the client device 130), as well as other systems (not illustrated) communicably coupled to the network 102. Generally, the interface 112 comprises logic encoded in software and/or hardware in a suitable combination and operable to communicate with the network 102. More specifically, the interface 112 may comprise software supporting one or more communication protocols associated with communications such that the network 102 or interface's hardware is operable to communicate physical signals within and outside of the illustrated environment 100.

The request handler 116 can, for example, handle requests received from systems and/or devices external to the server system 110. For example, the request handler 116 can handle a request received from the client device 130 for the productive code 122 or injectable code 124. In some implementations, the client device 130 can request current or other versions of productive code 122 and/or injectable code 124 from the server system 110. In some implementations, the server system 110 can push productive code 122 and/or injectable code 124 to one or more client devices 130.

The user interface 118 (or sub-components therein) provides an application by which a software developer or tester can, among other things, generate injectable code. For example, the user interface 118 can provide an editor for developing lines of code and/or other components of the injectable code. In some implementations, the user interface 118 can include multiple screens, e.g., for displaying the productive code and the injectable code simultaneously.

A toolbox 126 can include tools for generating injectable code 124. For example, tools from the toolbox 126 can appear in the user interface 118 during development of injectable code. The tools can include, for example, keywords and/or other user-selectable widgets that can be provided within an integrated development environment (IDE) for use in generating injectable code 124 from the productive code 122.

The server system 110 also includes the memory 120, or multiple memories 120. The memory 120 may include any type of memory or database module and may take the form of volatile and/or non-volatile memory including, without limitation, magnetic media, optical media, random access memory (RAM), read-only memory (ROM), removable media, or any other suitable local or remote memory component. The memory 120 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server system 110. Additionally, the memory 120 may include any other appropriate data, such as VPN applications, firmware logs and policies, firewall policies, a security or access log, print or other reporting files, as well as others. In some implementations, memory 120 includes the productive code 122, the injectable code 124, and the toolbox 126. Other components within the memory 120 are possible.

The illustrated environment of FIG. 1 also includes the client device 130, or multiple client devices 130. The client device 130 may be any computing device operable to connect to, or communicate with, at least the server system 110 over the network 102 using a wire-line or wireless connection. In general, the client device 130 comprises an electronic computer device operable to receive, transmit, process, and store any appropriate data associated with the environment 100 of FIG. 1.

The illustrated client device 130 further includes at least one client application 134. Each client application 134 can be any type of application that allows the client device 130 to request and view content, such as a Web browser or any other application that may display or use content. Other client applications 134 can include business applications, games, embedded systems (e.g., medical devices, airline/defense systems, etc.) and any other applications that can run on a client device 130, with or without user interaction.

The illustrated client device 130 further includes a code injector 136 for injecting injectable code 144 into the productive code 142, at runtime and without modifying the productive code. For example, when a client application 134 is being prepared or selected for execution, the code injector 136 can determine if associated injectable code 144 exists. If so, then the code injector 136 can inject the injectable code 144 at runtime. In some implementations, the code injector 136 can make use of injection application programming interfaces (APIs) 146. The injection APIs 146, for example, can include functions and/or specifications that define how software components should interact with each other, e.g., so that the code injector 136 can inject injectable code 144 into productive code 142 at execution time.

The illustrated client device 130 further includes an interface 138, a processor 132, and a memory 140. The interface 138 is used by the client device 130 for communicating with other systems in a distributed environment—including within the environment 100—connected to the network 102. The interface 138 can support, for example, requests sent by the client device 130 for productive code and injectable code, productive code received from the server system 110 (and stored locally as productive code 142), and injectable code received from the server system 110 (and stored locally as injectable code 144). The interface 138 can also be used to send reports to the server system, e.g., that provide information about the execution of productive code 142, including as patched by injectable code 144. Generally, the interface 138 comprises logic encoded in software and/or hardware in a suitable combination and operable to communicate with the network 102. More specifically, the interface 138 may comprise software supporting one or more communication protocols associated with communications such that the network 102 or interface's hardware is operable to communicate physical signals within and outside of the illustrated environment 100.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including JavaScript™, Hyper-Text Mark-up Language (HTML), C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

As illustrated in FIG. 1, the client device 130 includes the processor 132. Although illustrated as the single processor 132 in FIG. 1, two or more processors 132 may be used according to particular needs, desires, or particular implementations of the environment 100. Each processor 132 may be a central processing unit (CPU), an application specific integrated circuit (ASIC), a field-programmable gate array (FPGA), or another suitable component. Generally, the processor 132 executes instructions and manipulates data to perform the operations of the client device 130. Specifically, the processor 132 executes the functionality required to send requests to, and process responses from, and the server system 110.

The illustrated client device 130 also includes a memory 140, or multiple memories 140. The memory 140 may include any memory or database module and may take the form of volatile or non-volatile memory including, without limitation, magnetic media, optical media, random access memory (RAM), read-only memory (ROM), removable media, or any other suitable local or remote memory component. The memory 140 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 130. Additionally, the memory 140 may include any other appropriate data, such as VPN applications, firmware logs and policies, firewall policies, a security or access log, print or other reporting files, as well as others.

The illustrated client device 130 is intended to encompass any computing device such as a smart phone, tablet computing device, PDA, desktop computer, laptop/notebook computer, wireless data port, one or more processors within these devices, or any other suitable processing device. For example, the client device 130 may comprise a computer that includes an input device, such as a keypad, touch screen, or other device that can accept user information, and an output device that conveys information associated with the client device 130, including digital data, visual information, or a graphical user interface (GUI) 131, as shown with respect to and included by the client device 130. The GUI 131 interfaces with at least a portion of the environment 100 for any suitable purpose, including generating a visual representation of a Web browser, providing an interface for displaying a control for initiating injectable code, and for other purposes.

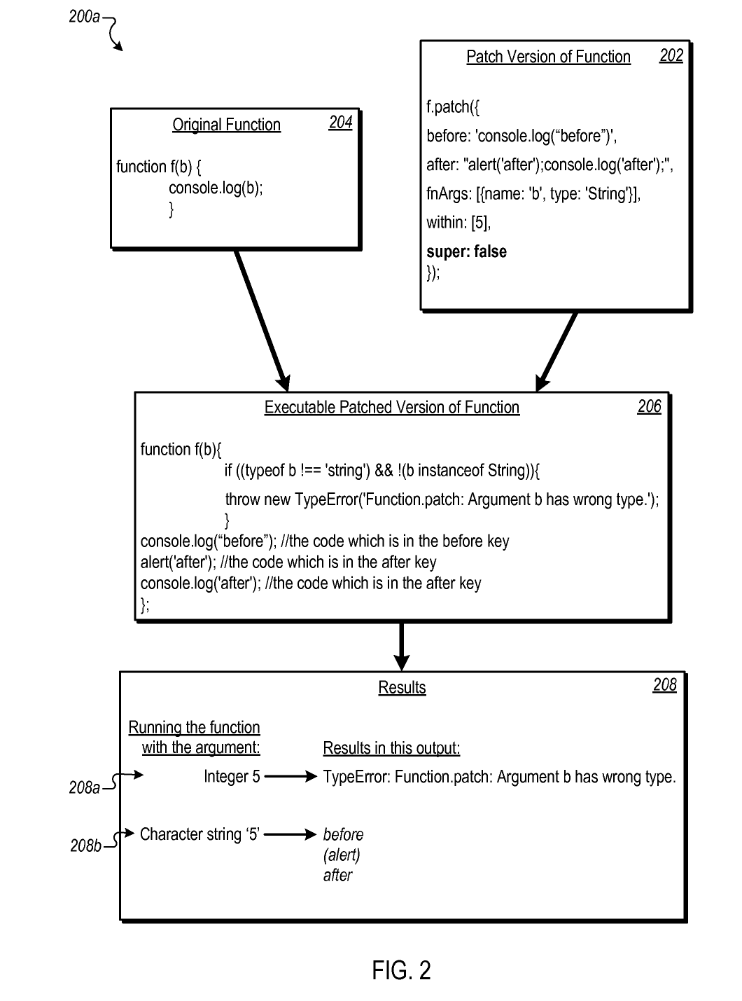

FIG. 2 shows an example of a runtime substitution 200a of injectable code 202. For example, the runtime substitution 200a can occur on the client device 130 using productive code 122 and injectable code 124 received from the server system 110. In some implementations, the runtime substitution 200a can also occur on the server system 110, e.g., as a test of the patched version of function “f” by a software developer or programmer using the user interface 118. This can occur at the server system 110, for example, before or after the injectable code 124 (e.g., that is stored as the injectable code 202) is provided to one or more client devices 130.

In the current example, an original function 204 is an example of productive code 122. The original function 204, for example, is a function named “f” that has a single argument “b” where the value of the argument “b” is written to a console using a “console.log(b)” statement. This example includes a single line of code within the function for purposes of illustration, but actual productive code can typically include hundreds or thousands of lines of code, statements and/or other elements. The term “function” used here can also represent any feasible calling or called module, and may also include main programs, methods, subroutines, scripts, or any other software- or application-related components.

The injectable code 202 is a patched version of the function “f” in which the keyword “patch” is used to indicate that this is a patched version of a productive version. The patched version includes a “before” statement and an “after” statement, each including a single executable statement that is to be executed at runtime before and after, respectively, an execution of the function (e.g., triggered by the “within” statement). In some implementations, blocks of statements can be used with “before” and “after” statements, e.g., so that multiple lines of code can be executed as needed.

Runtime substitution 206 shows an example of statements that are executed (e.g., on the client device 130) for the patched version of function “f” at runtime. In this example, the runtime substitution 206 uses inputs from the original function “f” (e.g., accessed at runtime from productive code 142) as modified by the patched version of “f” (e.g., obtained from the injectable code 144). For example, when the client application 134 executes on the client device 130, e.g., whenever the function “f” is called or invoked, the code injector 136 can look for a patched version (e.g., named “fpatch”) in the injectable code 144. If a patched version is located, then that patched version is executed instead of the productive version. Lines of code from the productive version of function “f” can still be used, e.g., because the lines of code (or other components) for function “f” are defined in the productive version. For example, the original function and its statements can be executed in the patched version using a “within” statement. In this example, what gets “injected” into code executed at runtime includes statements defined in the “fipatch” version. This occurs, for example, without modifying the productive code for function “f” which allows other applications using function “f” to use the productive version.

Results 208 show example inputs and outputs that can be expected when the patched version of function “f” executes. For example, in results 208a, if the patched version of function “f” is invoked using an integer (or numeric) value of 5, then an error is thrown or raised indicating that the data type of the input parameter “b” is incorrect, e.g., not a string as expected. In another example, in results 208b, if the patched version of function “f” is invoked using a character string of ‘5’, then the data type of the input parameter can be determined to be correct, and the patched version of function “f” does not get trapped in the error logic. Instead, the remaining statements of “fpatch” are executed, resulting in output that includes “before . . . (alert) . . . after” (e.g., written to the console).

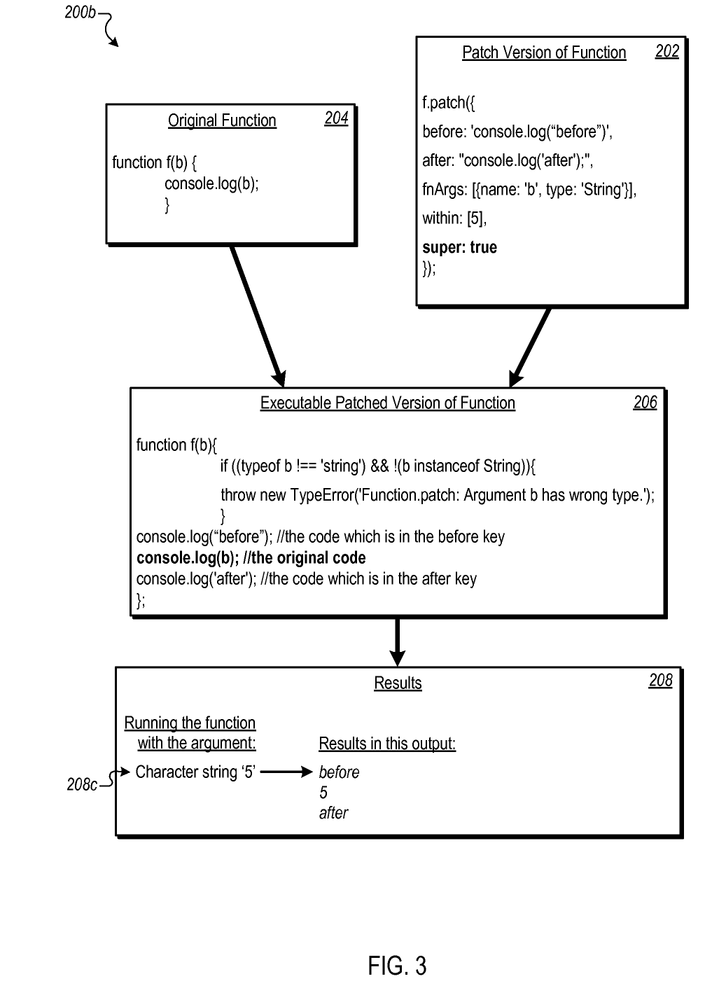

FIG. 3 shows an example of a runtime substitution 200b of injectable code 202. This example is similar to the example described with respect to FIG. 2 and includes the use of the same original function 204 of the productive code (e.g., function “f”). However, in this example, the injectable code 202 is different. Specifically, the injectable code 202 includes the statement “super: true” instead of “super: false” used in the other example. In this way, the original functionality of function “f” is to be executed.

In this example, the runtime substitution 206 is slightly different, reflecting the different version of the injectable code 202. Specifically, the “super” statement in the injectable code 202 has caused the original version of the function “f” to be inserted. As such, results 208c include, as an output, the string ‘5’ written to the console.

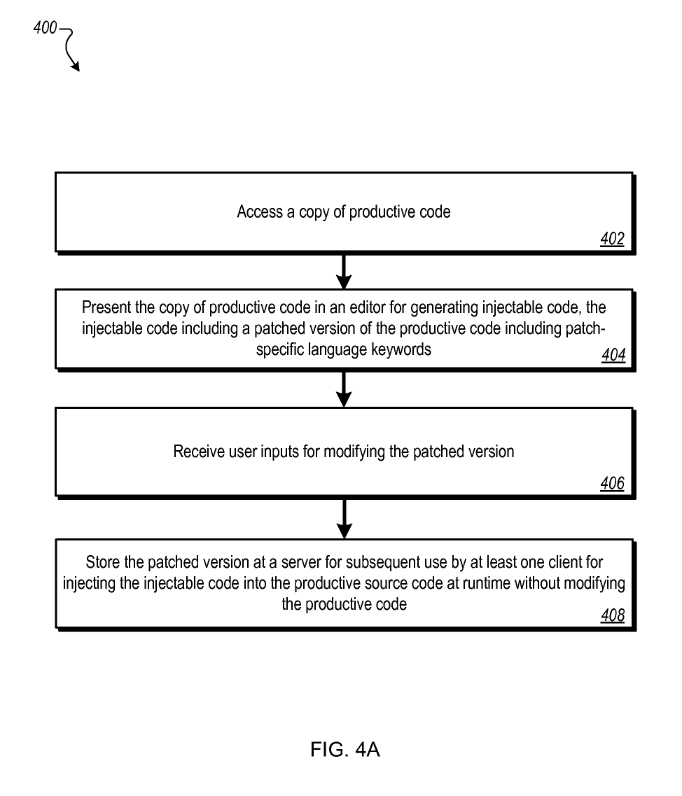

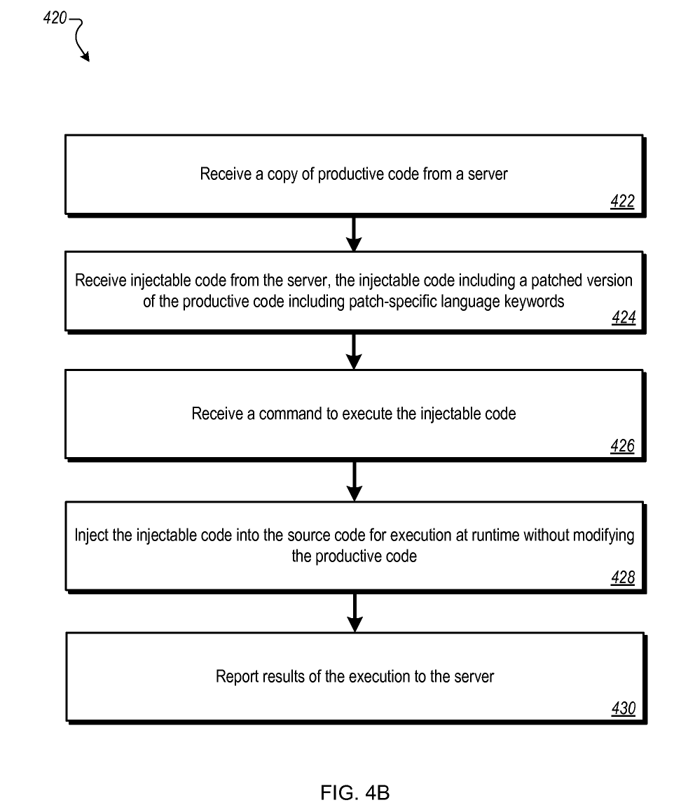

FIG. 4A is a flowchart of an example method 400 for producing injectable code and storing the injectable code at a server for subsequent use. For clarity of presentation, the description that follows generally describes method 400 in the context of FIGS. 1 through 3. However, it will be understood that the method 400 may be performed, for example, by any other suitable system, environment, software, and hardware, or a combination of systems, environments, software, and hardware as appropriate. For example, the server system 110 and/or its components can be used to execute the method 400. The injectable code 202 is one example outcome of the method 400. For example, the stages of the method 400 can result in the creation of the patched version of function “f”, namely the patched version “fpatch.” that is included in the injectable code 202.

At 402, a copy of productive code is accessed. For example, the user interface 118 can access productive code 122, e.g., including an original version of function “f” which is also the productive version.

At 404, the copy of productive code is presented in an editor for generating injectable code. The injectable code includes a patched version of the productive code including patch-specific language keywords. For example, the user interface 118 can present an interface that includes a version of the function “f” provided in an editor for use by the user in modifying the patched version. The version provided can include, for example, at least one keyword, e.g., the keyword “patch” that signifies that the version of function “f” being presented to the user is a patched version.

At 406, user inputs are received for modifying the patched version. For example, the user can edit the modified version of the function in order to develop a modified version to be used as injectable code. In some implementations, the user can select from controls, e.g., to select keywords and/or other language elements or constructs for inclusion in the injectable code.

In some implementations, keywords usable injectable code can include the following. The keyword “patch” after the function name can indicate that the function is a patched (e.g., non-productive) version. A “before” keyword can indicate, for example, that the statement(s) following the “before” statement are to be executed before execution of the original function when the patched version is executed at runtime. In this way, the statements are prepended to the body of the original function. An “after” keyword can indicate, for example, that the statement(s) following the “after” statement are to be executed after execution the original function when the patched version is executed at runtime. In this way, the statements are appended to the body of the original function. A fnArgs keyword (e.g., implemented as “fnArgs: [{name: ‘b’, type: ‘Number’}]”) can define, for example, the argument(s) of the patched version of the function and their corresponding data type(s). A “within” keyword can cause, for example, execution of the original function, using argments provided (e.g., as “within: [args....]”). A “super” keyword, when set to true (e.g., the default), can indicate, for example, to execute the original functionality. An “around” statement can be used, for example, to execute specified code before and after the execution of the productive version. Other keywords are possible, e.g., including keywords that limit the number of times that the patched version is to be used (e.g., only the first time), at which point the original version is used and not the injected version.

At 408, the patched version is stored at a server for subsequent use by at least one client for injecting the injectable code into the productive source code at runtime without modifying the productive code. For example, the user interface 118 can store the completed, edited version of the patched version of the function in the injectable code 124.

In some implementations, the interface 112 can send the injectable code 124 to one or more client devices 130 on an as-needed basis, e.g., whenever productive code 122 is provided, or subsequently to diagnose problems with, or obtain diagnostics from, the client devices 130 regarding the productive code 160.

In some implementations, the method 400 further includes steps for initiating the use of injected code and receiving information associated with its execution. A command is provided to the at least one client to use the injectable code for an execution of the productive code. For example, the server system 110 can provide a command to one or more client devices to inject injectable code during subsequent execution(s) of the productive code. After subsequent execution of the injectable code, information is received reporting results of the execution. For example, the server system 110 can receive reports from the one or more client devices 130 regarding the execution of the code. The information is stored for subsequent analysis. As an example, the server system 110 can store the information, e.g., to be used later by software engineers or other personnel to evaluate the performance of the code.

In some implementations, patched versions can be grouped into groups and used as a group. A designation is received of a group identifier for grouping one or more productive code elements into a group. The provided to the at least one client to use the injectable code for an execution of the productive code includes the group identifier identifying the one or more productive code elements of the injectable code to be injected for the execution. For example, when the server system 110 provides a command to one or more client devices 130 to include injectable code for subsequent execution(s), the command can include a identifier that identifies the group of code elements for which patch versions are to be used.

FIG. 4B is a flowchart of an example method 420 for using injectable code at a client, including injecting the injectable code at runtime. For clarity of presentation, the description that follows generally describes method 420 in the context of FIGS. 1 through 3. However, it will be understood that the method 420 may be performed, for example, by any other suitable system, environment, software, and hardware, or a combination of systems, environments, software, and hardware as appropriate. For example, the client device 130 and/or its components can be used to execute the method 420, e.g., using information received from the server system 110. The runtime substitution 206, for example, represents one possible outcome of the method 420, in that the patched version of function “f” is injected at runtime.

At 422, a copy of productive code is received from a server. For example, the client device 130 can receive productive code 122 from the server system 110. The productive code can be stored at the client device 130 as productive code 142. At any given time, when productive code is received and stored, old versions of the productive code can be overwritten.

At 424, injectable code is received from the server. The injectable code includes a patched version of the productive code including patch-specific language keywords. For example, the client device 130 can receive injectable code 124 from the server system 110 and stored at the client device 130 as injectable code 144. At any given time, when injectable code is received and stored, old versions of the injectable code can be overwritten. This can occur, for example, on a function-by-function basis.

At 426, a command is received to execute the injectable code. For example, a user using the client application 134 can select a control to initiate execution of an application that will execute the injectable code 144, e.g., as a patch of the productive code 142. In systems in which the client device 130 has no direct user interface, the command to execute the injectable code can be received from the server system 110 or from some other source.

At 428, the injectable code is injected into the source code for execution at runtime without modifying the productive code. For example, the client application 134 can execute, and the injectable code 144 can be automatically injected by the code injector 136 into the productive code 142 at runtime.

At 430, results of the execution are reported to the server. As an example, statements or other constructs in the injectable code 144 can cause information regarding the execution of code to be logged in a file or report and sent to the server system 110 or some other place. Other types of notifications are possible, including email messages, text messages, phone calls, and/or other forms of communication.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, example environment 100 may use processes with additional, fewer and/or different operations, as long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method comprising:
accessing a copy of productive code;
presenting the copy of productive code in an editor for generating injectable code, the injectable code including a patched version of the productive code including patch-specific language keywords;
receiving user inputs for modifying the patched version; and
storing the patched version at a server for subsequent use by at least one client for injecting the injectable code into the productive source code at runtime without modifying the productive code.

2. The method of claim 1, further comprising:
providing, to the at least one client, a command to use the injectable code for an execution of the productive code;
receiving, after subsequent execution of the injectable code, information reporting results of the execution; and
storing the information for subsequent analysis.

3. The method of claim 2, further comprising:
receiving a designation of a group identifier for grouping one or more productive code elements into a group, wherein the command includes the group identifier identifying the one or more productive code elements of the injectable code to be injected for the execution.

4. The method of claim 1, wherein productive code includes productive code elements selected from the group comprising source code, business objects, data bases, data tables, flat files, or programmable read-only memory.

5. The method of claim 1, wherein the patched version invokes the productive code.

6. The method of claim 1, wherein the patch-specific language keywords include:
a before keyword for identifying code to run before executing the productive code;
an after keyword for identifying code to run after executing the productive code;
a within keyword for triggering an execution of the productive code;
an around keyword for executing specified code before and after executing the productive code;
a fnArgs keyword for defining new arguments for the function; and
a super flag for specifying whether or not to run the original functionality.

7. A computer-implemented method comprising:
receiving a copy of productive code from a server;
receiving injectable code from the server, the injectable code including a patched version of the productive code including patch-specific language keywords;
receiving a command to execute the injectable code;
injecting the injectable code into the source code for execution at runtime without modifying the productive code; and
reporting results of the execution to the server.

8. The method of claim 7, further comprising:
receiving, from the server, a command to use the injectable code for an execution of the productive code; and
providing, to the server and after subsequent execution of the injectable code, information reporting results of the execution.

9. The method of claim 8, further comprising:
receiving a designation of a group identifier for grouping one or more productive code elements into a group, wherein the command includes the group identifier identifying the one or more productive code elements of the injectable code to be injected for the execution.

10. The method of claim 7, wherein productive code includes productive code elements selected from the group comprising source code, business objects, data bases, data tables, flat files, or programmable read-only memory.

11. The method of claim 7, wherein the patched version invokes the productive code.

12. The method of claim 7, wherein the patch-specific language keywords include:
a before keyword for identifying code to run before executing the productive code;
an after keyword for identifying code to run after executing the productive code;
a within keyword for triggering an execution of the productive code;
an around keyword for executing specified code before and after executing the productive code;
a fnArgs keyword for defining new arguments for the function; and
a super flag for specifying whether or not to run the original functionality.

13. A computer-program product, the computer program product comprising computer-readable instructions embodied on tangible, non-transitory media, the instructions operable when executed by at least one computer to:
receive a copy of productive code from a server;
receive injectable code from the server, the injectable code including a patched version of the productive code including patch-specific language keywords;
receive a command to execute the injectable code;
inject the injectable code into the source code for execution at runtime without modifying the productive code; and
report results of the execution to the server.

14. The computer-program product of claim 13, further comprising instructions to:
receive, from the server, a command to use the injectable code for an execution of the productive code; and
provide, to the server and after subsequent execution of the injectable code, information reporting results of the execution.

15. The computer-program product of claim 13, further instructions to:
receive a designation of a group identifier for grouping one or more productive code elements into a group, wherein the command includes the group identifier identifying the one or more productive code elements of the injectable code to be injected for the execution.

16. The computer-program product of claim 13, wherein productive code includes productive code elements selected from the group comprising source code, business objects, data bases, data tables, flat files, or programmable read-only memory.

17. A system, comprising:
memory operable to store content, including static and dynamic content; and
at least one hardware processor interoperably coupled to the memory and operable to perform instructions to: receive a copy of productive code from a server;
receive injectable code from the server, the injectable code including a patched version of the productive code including patch-specific language keywords;
receive a command to execute the injectable code;
inject the injectable code into the source code for execution at runtime without modifying the productive code; and
report results of the execution to the server.

18. The system of claim 17, further comprising instructions to:
receive, from the server, a command to use the injectable code for an execution of the productive code; and
provide, to the server and after subsequent execution of the injectable code, information reporting results of the execution.

19. The system of claim 17, further instructions to:
receive a designation of a group identifier for grouping one or more productive code elements into a group, wherein the command includes the group identifier identifying the one or more productive code elements of the injectable code to be injected for the execution.

20. The system of claim 17, wherein productive code includes productive code elements selected from the group comprising source code, business objects, data bases, data tables, flat files, or programmable read-only memory.
